(19) United States
(12) Patent Application Publication
(10) Pub. No.: US 2012/0227257 A1
(43) Pub. Date: Sep. 13, 2012

(54) COUPLER DEVICE

(76) Inventor: Michael V. Kalavitz, Plainwell, MI (US)

(21) Appl. No.: 13/413,127

(22) Filed: Mar. 6, 2012

Related U.S. Application Data
(60) Provisional application No. 61/450,000, filed on Mar. 7, 2011.

(51) Int. Cl. H01R 43/00; F16B 7/00; B23P 11/00; H01R 24/00

(52) U.S. Cl. 29/825; 439/626; 403/300; 29/525.01

(57) ABSTRACT

A coupler assembly is disclosed comprising: a mounting sleeve including at least one L-shaped slot; a mounting support including an insertion stud, the insertion stud configured to fit into the mounting sleeve; the insertion stud further including a radial through-hole: a compression spring disposed over the insertion stud, the compression spring functioning to exert a separation force between the mounting sleeve and the mounting support; and a retaining pin disposed in the radial through-hole wherein the insertion stud is inserted into the mounting sleeve by sliding an end of the retaining pin inside the at least one L-shaped slot.

### CROSS REFERENCE TO RELATED APPLICATION

The present application is related to Provisional patent application entitled “Coupler Device,” filed 7 Mar. 2011 and assigned filing No. 61/450,000, and is incorporated herein by reference in its entirety.

### FIELD OF THE INVENTION

The present invention relates generally to coupler devices and, more specifically, to providing electro/mechanical coupling/uncoupling mechanisms that also function to reduce the incidence of contamination and coupler component failure.

### BACKGROUND OF THE INVENTION

There are known in the relevant art, various configurations of mechanical coupler assemblies, including pneumatic and hydraulic quick-coupler designs. Such pneumatic/hydraulic coupler assemblies are routinely also employed for use in coupling mechanical components that are not part of a pneumatic or hydraulic system. It has been observed that using these pneumatic/hydraulic couplers for unintended applications often results in failure because of coupler component contamination and improper application.

What is needed is an electro/mechanical coupling/uncoupling mechanism which overcomes problems of the current state of the art.

### BRIEF SUMMARY OF THE INVENTION

In one aspect of the present invention, a coupler assembly comprises: a mounting sleeve including at least one L-shaped slot; a mounting support including an insertion stud, the insertion stud configured to fit into the mounting sleeve: the insertion stud further including a radial through-hole; a compression spring disposed over the insertion stud, the compression spring functioning to exert a separation force between the mounting sleeve and the mounting support; and a retaining pin disposed in the radial through-hole wherein the insertion stud is inserted into the mounting sleeve by sliding an end of the retaining pin inside the at least one L-shaped slot.

In another aspect of the present invention, a coupler assembly comprises: a mounting sleeve including a first L-shaped slot and a second L-shaped slot; a mounting support including an insertion stud having a substantially circular cross section, the insertion stud configured to fit into a substantially cylindrical sleeve cavity in the mounting sleeve; a compression spring disposed over the insertion stud, the compression spring disposed against a first washer positioned proximate the mounting support, the compression spring further disposed against a second washer positioned proximate the mounting sleeve; and a retaining pin disposed in a radial through-hole provided in the insertion stud, a first end of the retaining pin disposed inside the first L-shaped slot and a second end of the retaining pin disposed inside the second L-shaped slot.

In still another aspect of the present invention, a method for coupling an accessory to a support structure comprises: obtaining a mounting sleeve having an L-shaped slot; securing a mounting support to the support structure, the mounting support having an insertion stud configured to fit into the mounting sleeve; emplacing a compression spring over the insertion stud; placing a retaining pin into a radial through hole disposed in the insertion stud, the retaining pin functioning to retain the compression spring on the insertion stud; placing the insertion stud into a sleeve cavity in the sleeve; and rotating the insertion stud relative to the mounting sleeve so as to seat the retaining pin in a slot detent in the L-shaped slot.

The additional features and advantages of the disclosed invention are set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a diagrammatical view of an exemplary embodiment of a mechanical coupling device disposed on a vehicle and supporting a flag assembly, in accordance with the present invention;

FIG. 2 is a diagrammatical view of the coupling device of FIG. 1, showing a mounting sleeve removably connected to a mounting support;

FIG. 3 is a diagrammatical view of the coupling device of FIG. 1, showing the mounting sleeve disconnected from the mounting support;

FIG. 4 is an exploded diagrammatical view of the coupling device of FIG. 1, showing the mounting sleeve, a pin washer, a compression spring, a flange washer, a retaining pin, and the mounting support;

FIG. 5 is a flow diagram explaining the coupling operation of the coupling device of FIG. 1;

FIG. 6 is an exploded diagrammatical view of an alternate exemplary embodiment of the coupling device of FIG. 1, showing first and second electrical connectors used within a mounting support;

FIG. 7 is a diagrammatical view of the electro/mechanical coupling device of FIG. 6 showing a drain slot in the mounting support; and

FIG. 8 is diagrammatical view of the electro/mechanical coupling device of FIG. 6 shown with the mounting sleeve coupled to the mounting support.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention. A coupler assembly is disclosed, suitable for use in quickly and rigidly coupling and uncoupling a removable device to a support structure, wherein the disclosed coupler assembly is designed without internal ball bearings or an internal spring, so at to overcome conventional contamination and failure problems. Accordingly, the disclosed coupler assembly not only eliminates contamination from being trapped between coupler components, but is also is easily cleaned by the user. Moreover, the disclosed coupler assembly functions to mitigate vibration between coupled parts by using an external compression spring to provide a pre-load at the coupling junction.

Certain terminology may be used in the following description for convenience and reference only, and will not be limiting. For example, the phrases “connected to,” “secured to,” or similar language include the definitions “indirectly connected to,” “directly connected to,” “indirectly secured to,” and “directly secured to.”

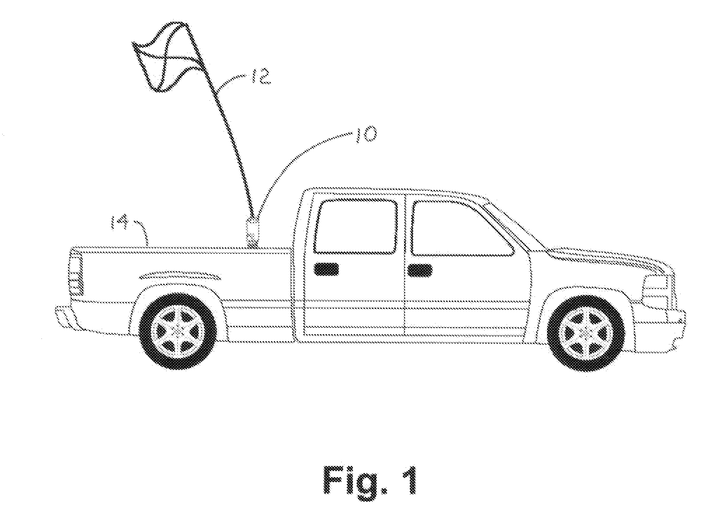

A typical application of a coupler assembly 10, in accordance with the present invention, is shown in the diagrammatical illustration of FIG. 1. The coupler assembly 10 functions to removably attach an accessory 12, such as a flag, or a banner with a mast, or any other removable accessory, to a support structure 14, here shown as a motor vehicle. The coupler assembly 10 may be adapted for use on other support structures such as, for example, a boat, a military tank, a wheel chair, a hospital bed, a mine shaft cart, or a space ship.

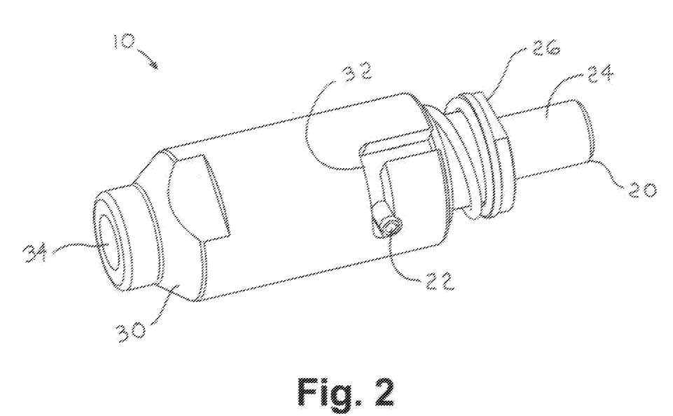

FIG. 2 provides a detailed diagrammatical view of the coupler assembly 10 in a coupled mode, the coupler assembly 10 comprising a substantially cylindrical mounting support 20 and a substantially cylindrical mounting sleeve 30. The mounting sleeve 30 and the mounting support 20 may comprise a metal, a plastic, a composite material, or another material suitable for use with the coupler assembly 10, as known in the relevant art. When coupled in accordance with an aspect of the present invention, the mounting support 20 is partially inserted into the mounting sleeve 30, and a retaining pin 22 functions to maintain the coupled configuration of the mounting sleeve 30 with the mounting support 20.

The retaining pin 22 may be fabricated as a solid pin or as a roll pin, either configuration providing for a press-fit of the retaining pin 22 into the mounting sleeve 30. In an exemplary embodiment, the retaining pin 22 may be approximately 0.1562 inches in diameter. The mounting sleeve 30 may include a first retaining L-shaped slot 32, substantially located as shown, and a second L-shaped slot 32 (hidden in the illustration provided) located on the mounting sleeve 30 approximately 180° from the first L-shaped slot 32. Each L-shaped slot is configured to slidably receive a respective end of the retaining pin 22, as described in greater detail below.

The mounting support 20 may include a threaded stud 24 configured to mate with a structural mounting feature or pad (not shown) secured to the support structure 14, the structural mounting feature having a threaded hole compatible with the threaded stud 24. In an alternative embodiment, the structural mounting feature or pad on the support structure 14 may include a non-threaded opening for receiving the threaded stud 24, and a nut/washer combination (not shown) may be used to secure the mounting support 20 to the structural mounting feature or pad, as well-known in the relevant art.

In an exemplary embodiment, the threaded stud 24 may comprise a %-20 UNF external thread. The mounting support 20 may further include a flange 26 having a diameter substantially the same as the outside diameter of the mounting sleeve 30. The mounting sleeve 30 may include a threaded hole 34 configured to mate with and retain one end (not shown) of the accessory 12. In an exemplary embodiment, the threaded hole 34 may comprise a ½-20 UNF internal thread.

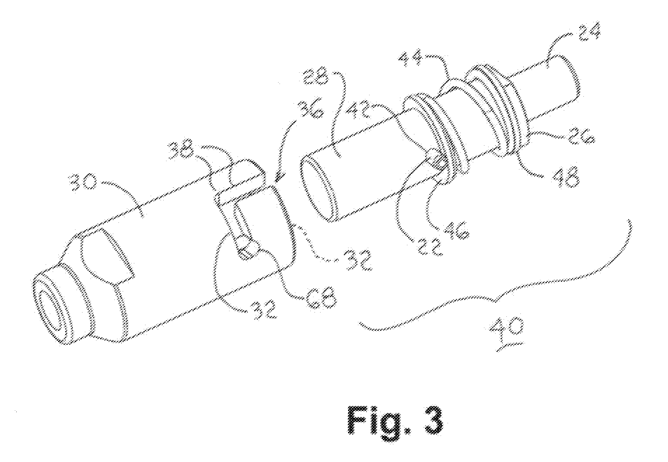

There is shown in FIG. 3 a detailed diagrammatical view of the coupler assembly 10 in an uncoupled mode, illustrating a configuration in which the mounting support 20 may have a substantially cylindrical insertion stud 28 configured to slide into and out of a substantially cylindrical sleeve cavity 36 in the mounting sleeve 30. The retaining pin 22 may be disposed in a radial through-hole 42 lying substantially on the diameter of the cross-sectional shape of the insertion stud 28. In an exemplary embodiment, the length of the retaining pin 22 is greater than the inside diameter of the cylindrical sleeve cavity 36 and, preferably, longer than the outside diameter of the mounting sleeve 30.

In an exemplary embodiment, the cylindrical insertion stud 28 and the cylindrical sleeve cavity 36 are machined to high roundness and diameter tolerances such that the cylindrical insertion stud 28 can be inserted into the cylindrical sleeve cavity 36 without requiring undue force by the user, but such that the cylindrical insertion stud 28 exhibits minimal lateral movement within the cylindrical sleeve cavity 36 when the support structure 14 is in motion, or when the accessory 12 is buffeted by an external force, such as wind. In an exemplary embodiment, the insertion stud 28 may be approximately 0.750 inches in diameter.

It can be appreciated by one skilled in the art that the cross-sectional shape of the insertion stud 28 is not limited to that of a circle, as in the provided example, and that other shapes can be used, including an oval, an ellipse, a polygon, or a convex shape, for example. The cross sectional shape of the sleeve cavity 36 may be an corresponding opening formed in congruence with the cross-sectional shape of the insertion stud 28.

Preferably, the geometry and fabrication tolerances of the coupler assembly 10 components are sufficiently small, so as to provide a close fit of the insertion stud 28 with the interior of the sleeve cavity 36. That is, the respective stud shape and cavity opening are machined to high tolerances so as to minimize clearance between the insertion stud 28 and the sleeve cavity 36 when mated. Accordingly, such a “dose fit” configuration prevents looseness between the insertion stud 28 and the sleeve cavity 36.

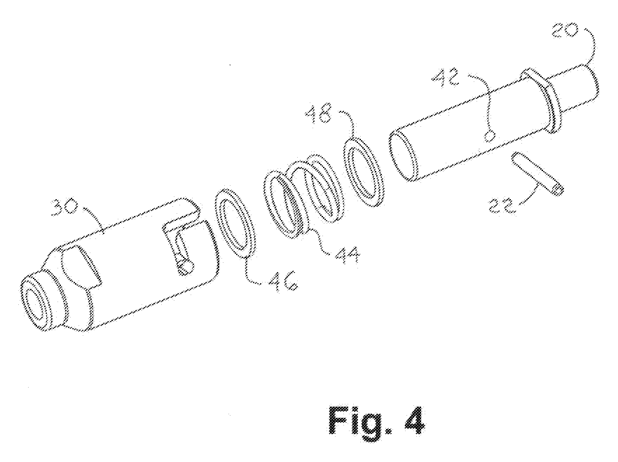

With additional reference to FIG. 4, it can be appreciated that when the retaining pin 22 is disposed in the radial through-hole 42, and engages, or slides inside, both the first L-shaped slot 32 and the second L-shaped slot 32, the retaining pin 22 may function to retain one end of a compression spring 44 on the insertion stud 28. The flange 26 may be configured and disposed to provide a bearing surface for the other end of the compression spring 44. It can be appreciated that the axis of the radial through-hole 42 is substantially perpendicular to the longitudinal axis of the insertion stud 28 so as to insure that respective ends of the retaining pin 22 similarly engages both the first L-shaped slot 32 and the second L-shaped slot 32. The compression spring 44 may be disposed in a pre-loaded state, or in a free-state, as may be specified by the design parameters of the coupler assembly 10. The compression spring 44 may be formed from an elastic material of uniform cross section, such as piano wire, as well-known in the relevant art.

A pin washer 46 may be provided between the compression spring 44 and the retaining pin 22. A flange washer 48 may be provided between the compression spring 44 and the flange 26. The distance between the flange 26 and the radial through-hole 42 may be substantially the same as the free length of the compression spring 44. The washers 46, 48 may be metal, plastic, composites, or other material suitable for use with the coupler assembly 10. The pre-loaded combination of the pin washer 46, the compression spring 44, and the flange washer 48 serves to exert a separation force between the mounting sleeve 30 and the mounting support 20.

As can be appreciated by one skilled in the art, when the coupler assembly 10 remains in a coupled state, the compression spring 44 remains in compression and exerts a pre-specified separation force, or preload, between the mounting support 20 and the mounting sleeve 30 such that movement of the mounting support 20 relative to the mounting sleeve 30 is mitigated or prevented. This preload serves to minimize vibration between the coupled mounting support 20 and the mounting sleeve 30, when the support structure 14 is in motion, or when the accessory 12 is buffeted by an external force, such as wind.

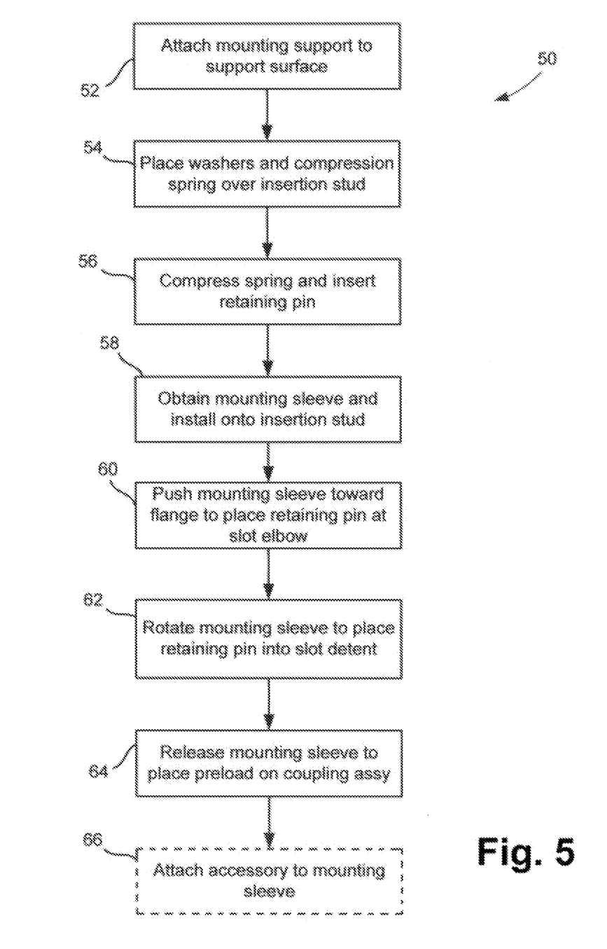

An exemplary method of utilizing the coupler assembly 10, as described in a flow diagram 50 in FIG. 5, may include the procedure of initially attaching the mechanical mounting assembly 40 to the support structure 14, at step 52, if not previously attached. The pin washer 46 may be provided between the compression spring 44 and the retaining pin 22. The flange washer 48, the compression spring 44, and the pin washer 48 may be placed over the insertion stud 28, at step 54. The pin washer 48 may be pressed to compress the compression spring 44, if needed, and the user may insert the retaining pin 22, at step 56.

The mounting sleeve 30 may be obtained, as step 58, and placed over the insertion stud 28 such that the retaining pin 22 enters the open end of the L-shaped slot 32 and “bottoms out” at a slot elbow 38, at step 60. Advantageously, this action may force the compression spring 44 into a substantially compressed state. When the retaining pin 22 has reached the slot elbow 38, the mounting sleeve 30 may be rotated with respect to the mounting support 20, at step 62, such that the retaining pin 22 is moved to and secured in a slot detent 68 at the terminal end of the L-shaped slot 32. This action places the compression spring 44 into a state of compression. In an exemplary embodiment, the accessory 12 may have been attached to the mounting sleeve 30 before the mounting sleeve 30 was placed over the insertion stud 28 and rotated.

When the retaining pin 22 is secured in the slot detent 68, the mounting sleeve 30 is effectively prevented from rotating with respect to the mounting support 20. The user may release the mounting sleeve 30, at step 64, to seat the retaining pin 22 in the slot detent 68, and allow the compression spring 44 to maintain a pre-load at the coupling junction. The accessory 12 may subsequently be secured in the threaded hole 34, at step 66, if the accessory 12 had not previously been attached to the mounting sleeve at step 58, above.

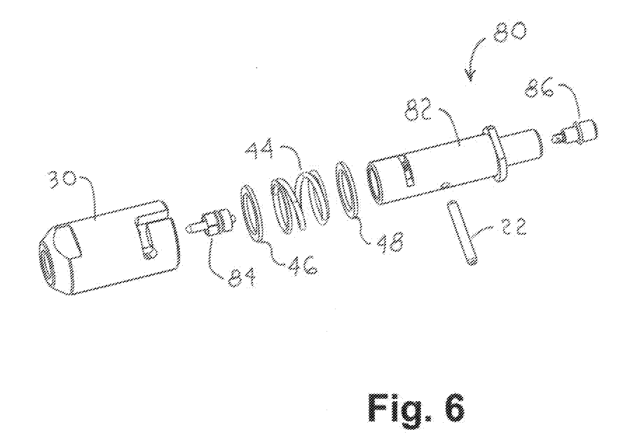

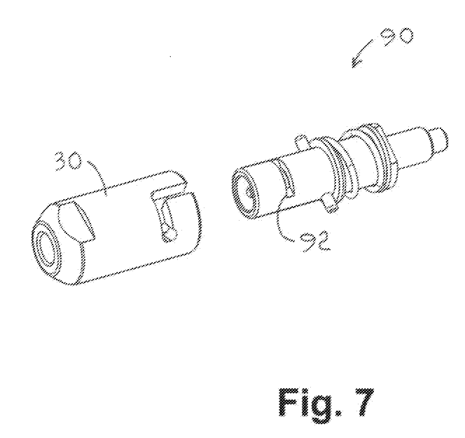

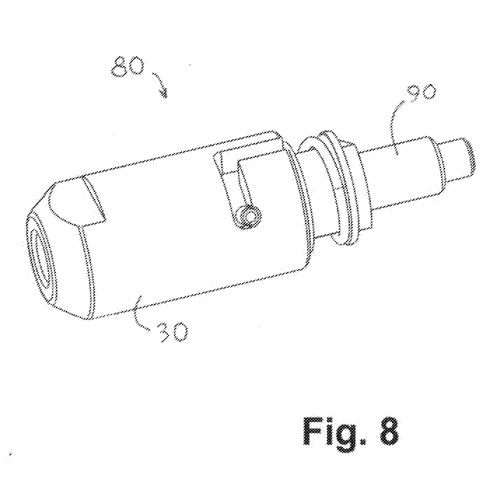

In an exemplary embodiment, shown in FIGS. 6-8, a coupler assembly 80 comprises the mounting sleeve 30 and an electrical mounting assembly 90. The electrical mounting assembly includes a substantially cylindrical mounting support 82. The mounting support 82 may be configured to accommodate a first electrical connector 84 and a second electrical connector 86, where the first electrical connector 84 may be in electrical communication with the second electrical connector 86 inside the mounting support 82. The first electrical connector 84 and the second electrical connector 86 may be included in the coupler assembly 80 to provide an electrical path between the support structure 14 and the accessory 12. The coupler assembly 80 may be particularly suitable in an application requiring electrical power to be provided by the support structure 14 to a component of the accessory 12, such as, for example, an illuminated flag (not shown).

The coupler assembly 80 is otherwise similar to the coupler assembly 10, described above, in that the electrical mounting assembly 80 also comprises the retaining pin 22, the pin washer 46, the compression spring 44, and the flange washer 48. In an exemplary embodiment, the electrical mounting assembly 90 may further comprise a drain slot 92, where the drain slot 92 functions to allow liquid and debris to drain from the mounting support 82. This configuration serves to keep the electrical connection between the first electrical connector 84 and the second electrical connector 86 relatively clean.

In the example provided, the first electrical connector 84 comprises a male connector and the second electrical connector 86 comprises a female connector. It can be appreciated by one skilled in the relevant art that other configurations lie within the scope of the present disclosure, including a reverse configuration (not shown) in which the first electrical connector 84 comprises a female connector and the second electrical connector 86 comprises a male connector.

It is to be understood that the description herein is exemplary of the invention only and is intended to provide an overview for the understanding of the nature and character of the disclosed illumination systems. The accompanying drawings are included to provide a further understanding of various features and embodiments of the method and devices of the invention which, together with their description serve to explain the principles and operation of the invention.

Furthermore, what has been described and illustrated herein are exemplary embodiments of the invention. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

What is claimed is:

1. A coupler assembly comprising:
a mounting sleeve including at least one L-shaped slot;
a mounting support including an insertion stud, said insertion stud configured to fit into said mounting sleeve; said insertion stud further including a radial through-hole;
a compression spring disposed over said insertion stud, said compression spring functioning to exert a separation force between said mounting sleeve and said mounting support; and
a retaining pin disposed in said radial through-hole wherein said insertion stud is inserted into said mounting sleeve by sliding an end of said retaining pin inside said at least one L-shaped slot.

2. The coupler assembly of dam 1 wherein said L-shaped slot comprises a slot detent configured to retain said retaining pin and prevent said mounting sleeve from rotating relative to said mounting support.

3. The coupler assembly of dam 1 further comprising a first washer disposed between said mounting sleeve and said compression spring and a second washer disposed between said compression spring and said mounting support.

4. The coupler assembly of dam 1 further comprising a drain slot disposed in said mounting support.

5. The coupler assembly of claim 1 wherein said insertion stud comprises a cross section configured as one of: a circle, an oval, an ellipse, a polygon, or a convex shape.

6. The coupler assembly of claim 1 wherein said mounting support comprises a threaded stud.

7. The coupler assembly of claim 1 wherein said mounting sleeve comprises a threaded hole.

8. The coupler assembly of claim 1 further comprising a second L-shaped slot disposed on said mounting sleeve, said second L-shaped slot disposed substantially 180° from said first L-shaped slot.

9. The coupler assembly of claim 1 wherein said mounting support comprises a flange configured to provide a bearing surface for said compression spring.

10. The coupler assembly of claim 1 further comprising a first electrical connector in electrical communication with a second electrical connector, said first electrical connector and said second electrical connector disposed within said mounting support.

11. A coupler assembly comprising:
a mounting sleeve including a first L-shaped slot and a second L-shaped slot;
a mounting support including an insertion stud having a substantially circular cross section, said insertion stud configured to fit into a substantially cylindrical sleeve cavity in said mounting sleeve;
a compression spring disposed over said insertion stud, said compression spring disposed against a first washer positioned proximate said mounting support, said compression spring further disposed against a second washer positioned proximate said mounting sleeve; and
a retaining pin disposed in a radial through-hole provided in said insertion stud, a first end of said retaining pin disposed inside said first L-shaped slot and a second end of said retaining pin disposed inside said second L-shaped slot.

12. The coupler assembly of claim 11 wherein said mounting support comprises at least one of a metal, a plastic, or a composite material.

13. The coupler assembly of claim 11 wherein said mounting support comprises at least one electrical connector.

14. The coupler assembly of claim 13 wherein said mounting support further comprises a drain slot disposed so as to minimize the accumulation of water proximate said at least one electrical connector.

15. The coupler assembly of claim 13 wherein said at least one electrical connector functions to provide part of an electrical path between a support structure attached to said mounting support and an accessory attached to said mounting sleeve.

16. A method for coupling an accessory to a support structure, said method comprising the steps of:
obtaining a mounting sleeve having an L-shaped slot;
securing a mounting support to the support structure, said mounting support having an insertion stud configured to fit into said mounting sleeve;
emplacing a compression spring over said insertion stud;
placing a retaining pin into a radial through hole disposed in said insertion stud, said retaining pin functioning to retain said compression spring on said insertion stud;
placing said insertion stud into a sleeve cavity in said sleeve; and
rotating said insertion stud relative to said mounting sleeve so as to seat said retaining pin in a slot detent in said L-shaped slot.

17. The method of claim 16 wherein said step of placing said insertion stud comprises the step of placing an end of said retaining pin into said L-shaped slot.

18. The method of claim 16 further comprising the step of securing an accessory into a threaded hole in said mounting sleeve.

19. The method of claim 16 wherein said step of turning said insertion stud functions to place said compression spring into a compressive state.

20. The method of claim 16 further comprising the step of providing a first electrical connector and a second electrical connector within said mounting support, said first electrical connector in electrical communication with said second electrical connector.
